(19) United States
(12) Patent Application Publication
(10) Pub. No.: US 2010/0287873 A1
(43) Pub. Date: Nov. 18, 2010

(54) DEVICE WITH A DIE RELIEF FOR MANUFACTURING A SLAB FROM AN EXTRUDABLE MATERIAL

(75) Inventors: Frank APPEL, Ulm (DE); Rainer KOCH, Senden (DE)

Correspondence Address: SCULLY SCOTT MURPHY & PRESSER, PC, 400 GARDEN CITY PLAZA, SUITE 300, GARDEN CITY, NY, 11530, US

(73) Assignee: Hans Lingl Anlagenbau und Verfahrenstechnik GmbH & Co. KG, Krumbach (DE)

(21) Appl. No.: 12/769,856

(22) Filed: Apr. 29, 2010

(30) Foreign Application Priority Data
May 12, 2009 (DE) 20 2009 006 795.5

(51) Int. Cl. E04C 1/00; B29C 47/16; B29C 47/92; B29C 47/08

(52) U.S. Cl. 52/596; 425/466; 425/142; 425/292

(57) ABSTRACT

The present invention is directed to a device for manufacturing a slab of extruded material, with a die relief, in which an outlet is arranged, of which the outlet edge determines an outlet cross-section with a given shape and size, wherein at least one peripheral portion of the outlet edge is arranged in a manner displaceable inwards and outwards transversely to the axis of the outlet and can be adjusted inwards and outwards by an adjustment device.

The invention relates to a device with a die relief for manufacturing a slab from an extrudable material according to the preamble of claim 1.

In the manufacture of formed stones or blocks, especially for the construction industry, for example, bricks, the extrusion of a slab of extrudable material, for example, clay-containing material, from an extrusion press and the cutting of the former into suitable, longitudinal portions, which, after further processing, for example, through drying or baking, provide bricks or respectively blocks with a desired strength, is already known.

With regard to the cutting of the longitudinal portions, cutting devices are now known, wherein the cutting of the slab is implemented with a transversely displaceable cutting wire, preferably into notches, which are pressed into the periphery of the slab, see, for example, DE 3306852 C1 and WO 2006/119929 A2.

For the manufacture of formed blocks, for example, made of concrete, the introduction and pressing of an appropriate material into a pressing mould, wherein the formed blocks receive the shape of the pressing mould is also known. In this context, the formation of material studs providing a lateral spacing element on the formed blocks in the form of small projections, which, in the laid condition of the formed blocks, ensure a joint spacing, which corresponds to the height dimension of the spacing elements and can be filled with joint material, is also known. Since the spacing elements are disposed at a distance disposed below the upper side of the formed blocks, they are not visible in the filled condition of the joints.

In the case of a manufacture of blocks in pressing moulds, removal from the moulds is problematic if spacing elements are provided, because a moulded part forming the spacing elements can only be removed from the mould in the height direction of the spacing element. In particular, if spacing elements are disposed on at least two sides of the block, a special separation of the mould is required, in order to remove the blocks from the mould, which is complicated both in terms of structure and handling.

The invention is based upon the object of developing a device of the type indicated in the introduction in such a manner that it is suitable for the manufacture of a slab with spacing elements. In this context, a simple and cost-favourably manufactured design or assembly and disassembly of the device or of the die relief should be possible.

This object is achieved by the features of claim 1. Advantageous further developments of the invention are described in the associated dependent claims.

The device according to the invention provides a die relief with a peripheral portion of the outlet edge, which can be adjusted inwards and outwards transversely to the axis of the outlet. This design allows material studs forming spacing elements to be provided on at least one side of the slab, wherein the projecting dimension of the at least one material stud is adjustable by an adjustment device of the peripheral portion directed outwards and inwards. Consequently, with the device according to the invention, a lateral surface of the slab can be manufactured with or without a material stud in a position of the peripheral portion appropriately adjusted inwards or outwards. Accordingly, the device is suitable for the production of both a slab with a material stud and also a slab without material stud.

With an adjustment during the extrusion, the device is also suitable not only for the production of material studs of the desired projecting dimension, but it is also possible to determine the beginning and the end of a material stud, and accordingly its length, by means of a targeted outward and inward adjustment of the peripheral portion taking into consideration the rate of extrusion.

Accordingly, it is also possible with the invention to determine the beginning and the end of a material stud in such a manner that they have a longitudinal spacing distance from cut surfaces, at which the slab is cut transversely, in order to produce blocks formed from longitudinal portions of the slab. In this context, the spacing distance of the material stud from the cut surface of the block guarantees that, in the laid condition of a block or paving stone formed in this manner, the material stud provides a spacing distance from the upper side of the block or paving stone and is therefore not visible.

The invention therefore allows a formation of a material stud on the slab exclusively through extrusion and therefore without material loss.

A peripheral portion adjustable inwards and outwards according to the invention can be realised in a simple, practical manner with a slider, which is mounted in the die relief in an adjustable manner transversely to the longitudinal axis of the outlet and is mounted in a manner displaceable by means of a drive device between an inner and outer position. This arrangement is made in such a manner that the slider projects, at least in its inner position, into an enlarged cross-section of the outlet and reduces the effective cross-section, and, in its outer position, enlarges the reduced cross-section.

There are several requirements for a block manufactured with the device and an associated slab cutting device. On the one hand, the block is a typical mass-produced product, which should be manufactured in a simple and cost-favourable manner. On the other hand, it must be taken into consideration that, during this manufacture, the intermediate product, the slab, from which the block is cut, comprises plastic material, which makes positioning and transportation difficult.

The invention is therefore based upon the further object of forming a block of the present type in such a manner that it can be manufactured with low cost and time requirement. Accordingly, the block should also be capable of being manufactured without substantial material loss.

This object is achieved by the features of the independent claim 17. Advantageous further developments of the invention are described in the associated dependent claims.

One substantial feature of the block according to the invention is that it is formed, including the material stud, exclusively by extrusion, and the material stud provides a spacing distance from at least one of the end surfaces of the block extending transversely to the direction of the extrusion. As a result, not only is a manufacture with low-cost guaranteed, because the slab is formed continuously as an intermediate product and requires only a cutting of the block, but also, the material stud can be manufactured without material loss in spite of its spacing distance from at least one end surface of the block, namely by extrusion, wherein the depth of a recess in the outlet edge of the die relief forming the material stud is reduced to zero during the extrusion. In this context, the material stud with its spacing distance from the at least one end surface is formed exclusively by extrusion and accordingly substantially without material loss. In cutting the block from the slab, a slight material loss occurs dependent upon the type of cutting device, for example, a cutting device with a cutting wire, however, this is very small and therefore negligible.

Further features of the block guarantee a simple laying of the block in a block bond. In this context, the block, for example, a block formed in an oblong manner, preferably formed in the shape of an oblong rectangle, can provide at least one material stud on one side, for example, on its broad side, and, on a side following this in the peripheral direction, for example, a narrow side, or also on both mutually opposing sides, for example, both narrow sides or broad sides.

The shape of the outlet or respectively of the block is not restricted to an oblong shape. For example, it can be square, round, oval or trapeze-shaped.

A further substantial feature is that, viewed in the projection directed at right angles to the narrow sides, the material studs disposed on the narrow sides are arranged offset relative to one another in such a manner that they are arranged side-by-side. This guarantees that, with blocks laid in a bond, material studs arranged on mutually opposing sides, which guarantee the width of the joints resulting between the blocks, do not but against one another being added to one another, but are arranged side-by-side.

Within the framework of the invention, however, it is also possible and advantageous for the purpose of material saving, to arrange the material studs disposed on the narrow sides and/or broadsides—viewed in the lateral or narrow-side or broad-side projection—one behind the other in such a manner, that the material studs of blocks laid in a bond are arranged one behind the other, so that their projecting dimensions are added to one another. Accordingly, the projecting dimensions need only correspond to half the joint width.

In the following section, a device according to the invention and a block according to the invention are explained in greater detail on the basis of exemplary embodiments and drawings. The drawings are as follows:

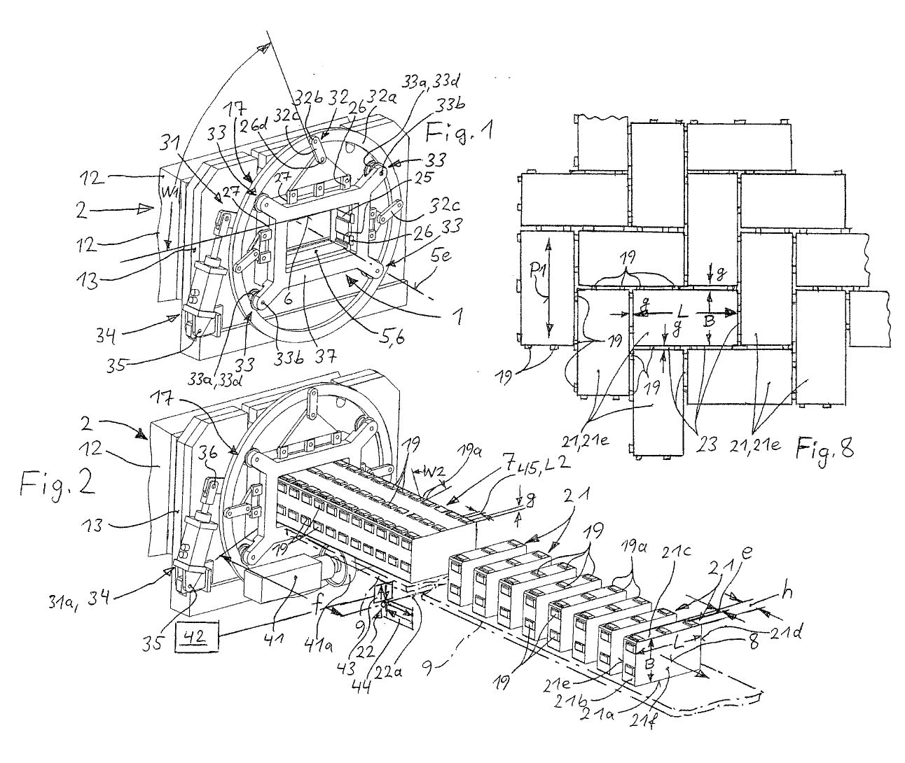

FIG. 1 shows a device according to the invention as a part of an extrusion press for the manufacture of a slab of extrudable material, in a perspective view from the front;

FIG. 2 shows the device with a slab produced from it and blocks produced from it, also in a perspective view;

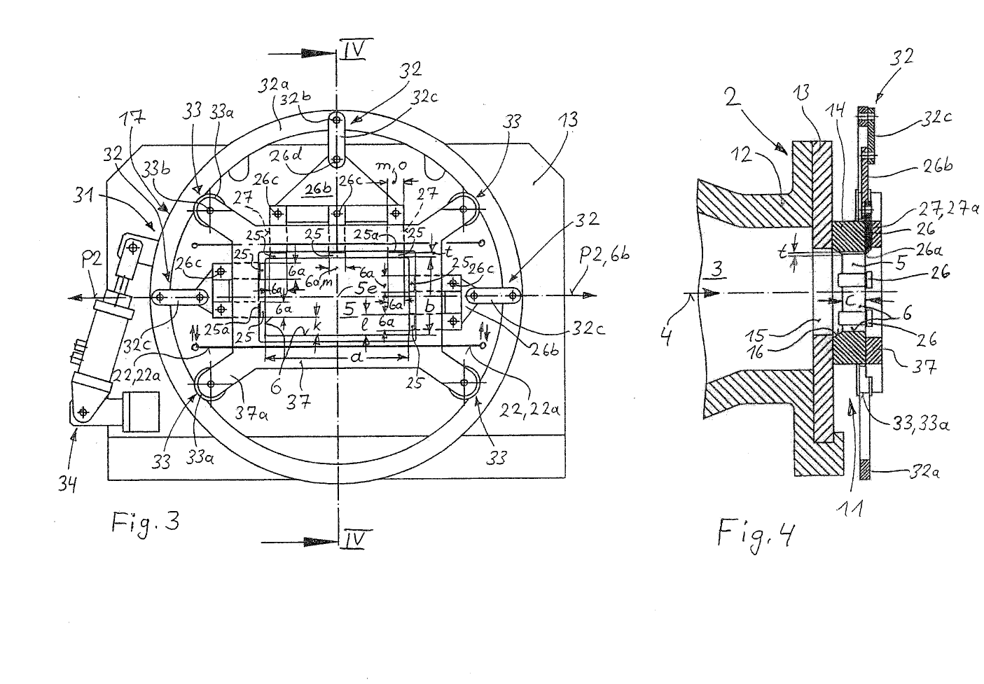

FIG. 3 shows the device according to the invention in a front view; and in a somewhat enlarged presentation;

FIG. 4 shows the section IV-IV from FIG. 3;

FIG. 5 shows the device in a modified form in a perspective, front view;

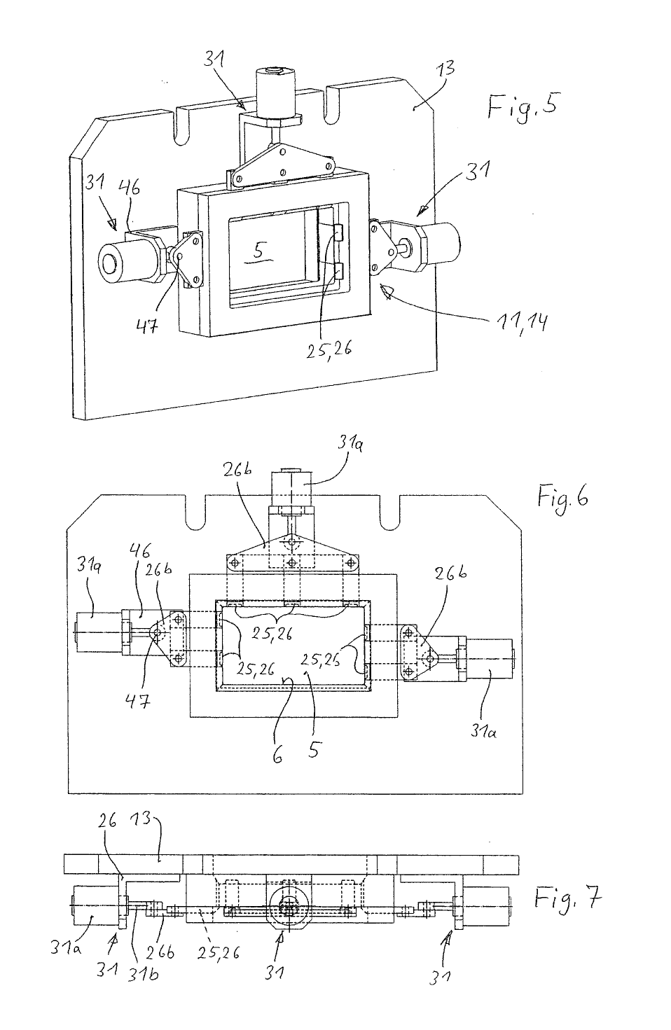

FIG. 6 shows the device according to FIG. 5 in a front view;

FIG. 7 shows the device according to FIG. 5 or 6 in a plan view;

FIG. 8 shows an arrangement of several blocks, which have been laid on a base in a bond.

Identical or comparable parts have been shown with the same reference numbers in all exemplary embodiments.

The device indicated in the drawings by reference number 1 is a part of a die or of a die relief of an extrusion press 2 illustrated in a simplified manner with a pressing cavity 3 and a pressing element 4 disposed within it in a displaceable manner and illustrated in a simplified manner as an arrow (FIG. 4) for extruding an extrudable material through an outlet 5 at the front end of the extrusion press 2. An outlet edge 6 of the outlet 5 determines the shape and cross-sectional size of a slab 7 illustrated in FIG. 2, which, during the functional operation of the extrusion press 2, is extruded from the outlet 5 towards the front in the extrusion direction 8 and transported further on an appropriate conveyor device 9.

The device 1 is integrated or mounted in a die 11 arranged at the front end of the extrusion press 2, for example, by means of a vertical mounting plate 13, the preferably flat, rear side of which is fitted and attached to the front side of the housing 12.

The outlet 5 is arranged in the die 11, wherein it is disposed in a die relief 14, which can be formed in one piece on the die 11 or can be attached to the mounting plate 13, for example, on the front side of the mounting plate 13. The mounting plate 13 provides a through perforation 15 disposed approximately coaxially with the outlet 5, which can, for example, be somewhat larger than the outlet 5, wherein an outlet taper 16 converging towards the front can be arranged in the transitional region between the outlet 5 and the through perforation 15.

Within the framework of the invention, the outlet 5 can provide an optionally required cross-sectional shape. With the present exemplary embodiment, the cross-sectional shape is substantially quadrilateral and rectangular, wherein it can be formed in an oblong manner and can provide a relatively longer, for example, horizontal, first cross-sectional dimension a and, for example, a vertical cross-sectional dimension b. As a result, in each case, mutually opposing narrow sides and broad sides of the cross-sectional shape of the outlet 5 are present. In order to minimise the surface pressure of the extruded slab 7 as much as possible, the longer cross-sectional dimension a is preferably arranged horizontally. However, the narrow-side, cross-sectional dimension can also be arranged horizontally, for example, for the manufacture of split tiles.

In theory, the dimension c of the internal surface area of the outlet 5 extending in the extrusion direction 8 can be small. In order to keep the dimensional accuracy and the cross-sectional shape of the slab 7 as constant as possible, it is advantageous to form the dimension c so large that it amounts to approximately ⅕ to ⅛ of the cross-sectional dimension a or b. However, the dimension c can also be larger. The internal peripheral surface of the outlet 5 formed in the exemplary embodiment by four inner sides 5a, 5b, 5c, 5d extends approximately parallel to its middle axis 5e.

According to the invention, the device 1 provides an adjustment device 17, with which it is possible to adjust at least one peripheral portion 6a of the outlet edge 6 transversely to the axis 5e of the outlet 5 optionally inwards and outwards. This design means that the cross-sectional dimension of the outlet 5 extending transversely to the peripheral portion 6a can be optionally reduced and enlarged. With a modification of this kind, it is possible not only to reduce or to enlarge the above-mentioned cross-sectional dimension, but also to determine the longitudinal position, at which a reduction or enlargement of the cross-sectional dimension of the outlet 5 is required, taking into consideration the rate, at which the slab 7 is extruded from the die 11. In this context, the cross-sectional reduction or enlargement can be implemented before or after a start of functioning of the extrusion press 2 or can be implemented during the extrusion process. In the first case, a step-shaped modification of the cross-sectional dimension is obtained, while in the second case—relative to the length of the slab 7—a continuous cross-sectional reduction or enlargement takes place, wherein, relative to the axis 5e, diagonal or rounded or wedge-shaped surface-area portions or front-face portions of the slab 7 can be produced.

The device 1 according to the invention is advantageously suitable for the formation of at least one, for example, point-shaped or rib-shaped material stud 19 on at least one of the lateral surfaces of the slab 7 or lateral surfaces 21a, 21b, 21c of blocks 21 formed from longitudinal portions of the slab 7, which can preferably be paving stones. Such longitudinal portions or blocks 21 are produced by a transverse cutting of the slab 7. A per se known cutting device 22 can be used for this purpose, which provides, for example, one or more cutting wires 22a extending transversely to the axis 5e and providing a longitudinal spacing distance from one another. This can be, for example, at least one cutting device 22, as described in DE 10 2005 063 327 of the applicant in conjunction with a notching of the slab 7 before the transverse cutting.

In FIGS. 2 and 3, only one cutting device 22 is illustrated by way of example.

On the basis of the adjustability of the at least one peripheral portion 6a, it is possible to determine the enlargement or reduction of the cross-sectional dimension taking into consideration the rate of extrusion and the axial spacing distance f of the cutting device 22 from the device 1 in such a manner that the material stud 19 provides an axial spacing distance from at least one cut surface of the blocks 21.

The device 1 according to the invention is therefore preferably suitable for the manufacture of paving stones, which provide a material stud 19 on at least one side, which guarantees a lateral dimension g (FIG. 7) for the formation of a joint 23 between two blocks 21 or paving stones laid adjacent to one another. Moreover, if the material stud 19 provides an axial spacing distance e from the upper side or top side 21e formed by a cut surface of the block 21 laid as a paving stone, then the material stud 19 is invisible in the laid and jointed condition of the associated paving-stone arrangement, because, in view of the spacing distance e, the material stud 19 is covered by the joint material and is therefore invisible.

The longitudinal-cross-sectional shape of the material stud/studs 19 can, for example, be trapeze-shaped.

By contrast, with regard to the underside 21f of the block 21, the material stud 19 or a material stud 19 may or may not be arranged at a spacing distance e from the underside 21f, because the underside region of the block is not visible from above. A spacing distance e of the material stud from both cut surfaces or from the upper and lower side of the block is particularly advantageous, so that the upper and lower side of the block can be used optionally as a surface visible from above.

The above description makes it clear that the device 1 according to the invention is suitable for the formation of one or more point-shaped or rib-shaped material studs 19 on one or more sides of the slab 7 or the blocks 21. The adjustable peripheral portion/s 6a of the outlet edge on one or more sides of the outlet 5 are used for the manufacture of the stud/studs 19. With this embodiment, one or more material studs 19 can be formed optionally on one or more sides of the blocks 21.

In order to facilitate the laying of a paving stone, namely, the positioning against an adjacent paving stone, and to preserve a spacing distance relative to the adjacent paving stone of the same size over the associated side, it is advantageous to arrange two material studs 19, which provide a horizontal spacing distance from one another and are preferably disposed in end regions of the respective side, especially a broad side, on at least one side, especially a broad side, of the blocks 21.

Furthermore, it is advantageous in the case of a cuboid block 21, to form the length L extending between the narrow sides approximately twice as long as the width B of the block 21 extending between the broad sides, wherein, by preference, a third material stud 19 is arranged in the middle, longitudinal region L of a broad side, and preferably, two material studs providing a horizontal spacing distance are arranged on one or both narrow sides. Especially the latter embodiment allows several blocks 21 to be laid in a so-called herring-bone pattern as shown in FIG. 8. A laying pattern of this kind can be determined as follows:

a) A plurality of a cuboid blocks 21 disposed with their broad sides adjacent to one another are arranged offset relative to one another along half of their broad sides in such a manner that a first diagonal row comprising blocks arranged in a staircase shape with stepped recesses at the sides is obtained.

b) Against this first row, on both sides, a second diagonal row of blocks 21 is placed in each case, which are rotated through 90° relative to the blocks 21 of the first row and are similarly offset along half of their broad sides in such a manner that they fill the stepped recesses of the first row and form stepped recesses for a next, first row of blocks on their side facing away from the first row.

In order to increase the laying options, the blocks 21 can provide material studs 19 on both narrow sides, wherein, however, these are arranged side by side in the longitudinal projection P1 (FIG. 8) extending transversely to the narrow sides, so that, for example, the two, material studs 19 arranged on both mutually opposing narrow sides, are not disposed in alignment with material studs 19 of adjacent blocks 21, to which their dimensions g would be added, but are disposed side-by-side, preferably disposed side-by-side parallel to the cut surfaces or respectively to the top side 21e.

In order to manufacture blocks 21 with the shapes described above, the device 1 provides peripheral portions 6a corresponding to the material studs 19 described above, which are adjustable optionally inwards and outwards through a corresponding enlargement or reduction transversely to the direction extending in the peripheral direction of the outlet 5.

If at least one material stud 19 is to be formed, of which the dimension extending in the peripheral direction of the outlet 5 provides only a part of the associated transverse dimension a, b, it is advantageous to arrange the peripheral portion 6a in the region of a recess 25 of the outlet edge 6 in such a manner that the depth t of the recess is adjustable between zero and a maximum dimension. Accordingly, in positions corresponding to the positions of the material studs 19, two end-face recesses 25 or also one central recess 25 can be arranged on a broadside of the outlet 5 and at least one or preferably two recesses 25 can be arranged on a side of the outlet 5 adjacent in the peripheral direction, here, the narrow side.

An adjustable peripheral portion 6a according to the invention can be formed in a simple and advantageous manner with a slider 26, which is adjustable inwards and outwards transversely to the outlet edge 6 or transversely to the base of the associated recess 25 and can be fixed in the adjusted position.

The exemplary embodiments each show a slider 26, which is displaceable within a guide 27 arranged on the die 11 and directed transversely to the axis 5e between a closed position closing the cross-section of the associated recess 25 and an open position releasing at least a part of the depth t of the recess 25 or releasing the recess 25 as a whole.

As with the block 21, in the device 1 also, the recesses 25 disposed on mutually opposite sides, especially narrow sides, of the outlet 5, are arranged side-by-side in a projection extending at right angles to the sides according to the arrow P2 (FIG. 3). That is to say, the respective recesses 25 in the exemplary embodiment are arranged offset in the peripheral direction of the outlet 5 in such a manner that, in each case on one side of the outlet 5, the spacing distance k of the side, for example, facing towards the lower outlet edge 6 of a recess 25, for example, of the left-hand lower recess 25, from the lower outlet edge 6, is larger than the spacing distance 1 of the side of the opposing recess 25 facing away from the lower outlet edge 6a. If two recesses 25 are arranged on each narrow side in the respective cross-section, this applies to them in a corresponding manner in the spacing-distance ratio relative to the lower or respectively upper outlet edge. In order to achieve a support with a sufficiently large angular stability in each case on the adjacent block 21, in the presence of two recesses arranged on each narrow side, it is advantageous to arrange one recess above and the other recess below the associated horizontal, cross-sectional middle axis 6b.

At the upper outlet edge, for example, at least two recesses 25 arranged in the end regions of the outlet edge 6 are present. By preference, in the exemplary embodiment, three recesses 25 are present, of which the middle one is arranged centrally and provides a width m extending in the peripheral direction, such that two blocks 21 formed with the device 1 with their broad sides providing no material studs 19, are placed in contact with the broad side of the first block 21 providing the material studs 19, and are therefore horizontally offset by half a dimension L, are in contact with the middle material stud 19, and accordingly provide a space holding, as shown in FIG. 8.

The material studs 19 are therefore described by way of example with reference to their shape, size and position. With regard to their number, shape and position, they can vary from those described above and can be formed in a different manner.

The arrangement and formation of a slider 26 relative to the associated recess 25 is, in principle, the same for all recesses 25 or respectively the peripheral edge portions formed by their recess base. Accordingly, the arrangement and function of only one slider 26 relative to the associated recess 25 is described in the following section.

The slider 26 preferably formed as a flat slider extends with its broad sides transversely to the middle axis 5e of the outlet 5 and also transversely to the associated outlet edge 6a. The slider 26 is displaceable by means of a drive device 31 with a drive motor 31a between an outer and its inner position. In the outer position, the inner front end 26a of the slider 26 can release the cross-section of the associated recess 25 and accordingly, relative to the base 25a of the recess 25, can be offset outwards or can project into the recess 25. Accordingly, the outer position can also be referred to as an open position. In the inner position, the slider 26 closes the recess 25, so that its front end 26a terminates with the periphery or outlet edge 6 of the outlet 5. Consequently, the depth t of the recess 25 can be adjusted by an adjustment of the slider 26. In this context, the slider 26 can be fixed by means of the associated drive device 31 only in its inner closed position and outer open position, or also, between these, in its optionally approachable intermediate positions, for example, fixed in a form-fit manner, as is the case with the present mechanical drive device 31.

In the exemplary embodiment, the width o of the slider 26 corresponds to the width m of the recess 25. However, the width o of the slider 26 can also be larger than the width m.

For several, for example, two or three, recesses 25 on one and the same side of the outlet 5, a common slider 26 can be provided. The exemplary embodiment shows two or three sliders 26, for example, in shape of fork, which are mounted on a common slider base 26b, for example, through an articulated joint with a joint pin 26c, and can accordingly be adjusted jointly with the drive device 31 optionally inwards and outwards. Instead of an articulated joint with a joint pin 26c, a rigid connection can be provided, for example, a detachable connection in the form of a screw connection.

The provision of a common drive device 31 and/or a common drive motor 31a for several sliders 26 or for all sliders 26 contributes to a further simplification.

A small and powerful structure is also achieved, if a drive device 31 is provided, which comprises a gearing 32, which converts a movement of a geared slider 32a directed in the peripheral direction into a movement of the slider 26 or respectively of the slider base 26b directed transversely to the peripheral direction. In this context, the gearing 32 can be formed by a connecting rod 32c connected to the geared slider 32a and the slider base 26b, in each case via an articulated joint 32b, 26d, which, in a starting position of the geared slider 32a, is disposed diagonally relative to the at least one slider 26 and is rotated by a curved-segment shaped movement of the geared slider 32a in the sense of a toggle drive into a rotational movement enlarging the angle W1 between itself and the outlet edge 6, and which accordingly moves the slider 26 into its inner closed position and vice versa.

In this context, the geared slider 32a can be displaced to and fro within a curved guide 33 extending in the peripheral direction.

With all of the exemplary embodiments, a piston cylinder 34 acting, for example, in both longitudinal directions, can act as the drive motor 31a, which is preferably supported by an articulated joint 35 against a stationary part of the device 1 and is connected through an articulated joint 36 to the geared slider 32 and is accordingly mounted in a rotatable manner within a transverse plane, which is directed at right angles to the axis 6e of the outlet 5.

The geared slider 32a is preferably an annular element and, for reasons of stability, preferably a closed ring, which is mounted in a reciprocally rotatable manner within the curved guide 33, preferably formed as a rotary guide. The curved guide 33 can be formed, for example, by at least three or more, for example, four, guide rollers 33a arranged distributed around the periphery, which are mounted in a rotatable manner about axes of rotation 33b of rotary bearings extending parallel to the outlet axis 5e, which the rotary ring 32d surrounds in a contacting manner with its internal periphery and is therefore mounted in a rotatable manner on the guide rollers 33a about the outlet axis 6e.

The rotary or curved guide 33 formed in this manner is held axially by radial guide surfaces on the guide rollers 33a in the sense of an axial bearing, which is formed in that the guide rollers 33a each provide within their surface areas a guide groove 33d, in which the rotary ring 32a engages with a motional play and is accordingly guided in an axially rigid manner.

The curved guide 33 or guide rollers 33a can be mounted, for example, on the housing 12 or on the die relief 14. In the exemplary embodiment, an annular or frame-shaped bearing part 37 is attached to the die relief 14, for example, to its front side, on the periphery of which or on bearing arms 37a projecting from the latter, the curved guide 33 is formed.

The guide 27 is preferably arranged between the die relief 14 and the bearing part 37, wherein the guide 27 can be formed by a guide recess 27a adapted to the cross-sectional shape and size of the slider 26, which can be arranged on the side of the bearing part 37 facing towards the die relief and/or on the front side of the die relief 14 or of the housing 12.

As is clearly evident from FIG. 4, the sliders 26 are designed in a wedge shape in the axial section preferably with a diagonal or rounded front face at the front end 26a and are therefore undercut.

FIGS. 2, 3 and 4 show the sliders 26 in their innermost, closed position; FIG. 1 shows them in the outer, open position.

The functioning of the device 1 or of the extrusion press 2 is described in the following section:

In functional operation, the extrudable material is extruded from the pressing chamber 3 of the extrusion press 2, through the outlet 5 in the extrusion direction 8, thereby forming the slab 7, the transport rate of which can be somewhat variable. This is dependent upon the pressure conditions, to which the extruded material is subjected in the region of the outlet 5. In this context, the quantity of material supplied to the die relief 14 determines the rate of the slab 7.

In order to determine the respective extrusion rate or output rate of the slab 7, a rate meter 41 is provided, which is arranged in the region between the die 11 or the die relief 14 and the cutting device 22, for example, at the front side, on the frame disposed in front of the die 11. The rate meter can e.g. be formed by a measuring wheel 41a acting on the slab 7 in contact with its periphery, which is rotated by the forward-moving slab 7 and which determines a rate parameter, which is communicated to an electrical control device 42, which controls a transverse drive device 43 of the cutting device 22 and accordingly controls the beginning and the cutting process for cutting blocks 21 from the slab 7.

The drive device 43 illustrated by way of example by two arrows directed in mutually opposing directions, moves the cutting wire 22a transversely to the slab, for example, vertically. In this context, the cutting device 22 is moved forward at the rate of transport of the slab 7 by a longitudinal slider 44 also illustrated by two arrows extending in the longitudinal direction of the slab 7, but in mutually opposing directions, during the transversely orientated cutting, at the rate of the slab, and is moved back into the starting position after cutting, thereby forming a cut orientated at right angles to the longitudinal axis of the slab.

In this context, after the cutting, the cutting wire 22a can be moved forward at the rate of the slab through a gap produced by spreading between the cut block 21 and the slab 7, and moved back to the starting side, and, after this, moved back into its original starting position opposite to the transport direction 8, which is referred to in the technical language as a mono-directional cutting.

However, after a cut, it is also possible to leave the cutting wire 22a on the respective side of the slab 7 and to move it back into its starting position opposite to the extrusion direction 8, from which the cutting wire 22a is moved transversely to the other side of the slab 7 for the next cut. In technical language, this cutting technique is referred to as “bidirectional cutting”. The previously described cutting techniques are per se known and do not therefore need to be described in further detail.

Within the framework of the invention, it is also possible to cut off a relatively longer longitudinal portion of the slab 7 as an intermediate portion and to move it transversely to the slab 7 into a stationary cutting position, where this slab portion can be cut without the previously described forward and backward movement of the cutting device 22 and of the slider bearing it (so-called harp cutter).

Otherwise, with all previously described embodiments, the cutting device 22 can be formed in each case with several cutting wires 22a each providing a spacing distance from one another distributed along the slab, so that several blocks 21 can be cut off in one cutting process.

The formation of the material studs 19 is realised as follows:

During the extrusion, the slider or the sliders 26 are moved by the drive 31 from the previously described closed position into the open position and vice versa, wherein the associated peripheral portion 6a controls the resulting cross-sectional modification of the outlet 5. Dependent upon how rapidly the slider 26 is moved into its open or respectively closed position, taking into consideration this rate of displacement and the extrusion rate, diagonal or rounded phases 19a on the material studs 19, which enclose an angle W2 (FIG. 2) between them, can be formed.

Before the slab 7 is moved forward in the extrusion direction 8 by a distance corresponding to the height h of extension of the block 21, the at least one slider 26 is moved into its closed position, in which the slab is extruded without a material stud 19. During the extrusion in the closed position of the slider 26, gaps 45 therefore occur between the material studs 19, the length L2 of which is determined by the stationary time, in which, the slider 26 is disposed in its closed position during the extrusion. This stationary time or respectively gap length L2 is controlled with the drive 31b in such a manner that at least one part of the length L2 is disposed in front of the position, at which the slab 7 will subsequently be cut, that is to say, at least one part of the length L2 or the length L2 corresponds to the spacing distance e, which the associated material stud 19 provides from the top surface or the subsequent upper side 21e.

It is also possible to control the drive 31b in such a manner that the spacing distance e extends backwards from the cut surface of the blocks 21 directed in the extrusion direction 8. In this case, the respective block 21 should be laid in such a manner that this cut surface is directed upwards during the laying and forms the upper side or respectively top surface 21e.

Moreover, with both operating and extrusion methods described above, it is possible to produce a spacing distance e from one or from both cut surfaces of the respective block 21. For this purpose, the respective slider 26 should be moved in its open position by the spacing distance e to a position in the slab 7, wherein the position corresponds to the position of the subsequently occurring first cut and/or should be moved into its closed position at a time corresponding to the spacing distance e before a second position, wherein the second position corresponds to the second cut position of the block 21.

A method for manufacturing the blocks 21 corresponding to that described above is described below with reference to the following method steps.

A method for manufacturing a block 21 from extrudable material, wherein the material is extruded through a die outlet 5, of which the outlet edge 6 determines the cross-sectional shape and size of a slab 7 resulting from the extrusion,

from which the block 21 is cut off transversely, wherein at least one peripheral portion 6a of the outlet edge 6 is adjusted inwards and/or outwards during the extrusion and, in this context, a reduced and/or enlarged cross-section of the slab 7 is extruded, and the block 21 is cut off in the longitudinal region L2 of the reduced cross-section.

In this context, it is advantageous that the peripheral portion 6 is left for a time in its position after its inwardly directed adjustment, and accordingly, a peripheral portion approximately parallel to the axis is extruded.

In order to cut off the block 21 from the slab 7, there are several possibilities, which lead to a spacing distance e of the material stud 19 from one or from both cut surfaces or respectively end surfaces of the block 21. Accordingly, it is possible to cut off the block 21 at the end or at the beginning or in the middle region e of the reduced slab cross-section.

The exemplary embodiment according to FIGS. 5 to 7 differs from the previously described exemplary embodiments in that several drives 31 are provided, for example, a drive 31a, 31b, 31c on each side with at least one adjustable peripheral portion 6a, wherein, instead of a common drive motor 31a, one drive motor 31a can be provided in each case, which drives or drive the slider/sliders 26 arranged on one or on both sides of the outlet 5 and/or on its upper side for its/their inward and outward displacement. These drive motors 31a can also be formed, for example, by piston cylinders 34, which are attached to mounting parts 46 projecting from the die 11, which are formed, for example, in an angled manner and can be attached to the mounting plate 13.

Accordingly, in the exemplary embodiment, two lateral and three upper-side sliders 26 are displaced jointly inwards or outwards in each case by an associated drive motor 31a. In this context, the piston rod 31b can engage on each slider base and can preferably be connected to the latter in a rotatable manner by an articulated joint 47.

1. A device for manufacturing a slab of extruded material, with a die relief, in which an outlet is arranged, of which the outlet edge determines an outlet cross-section with a given shape and size,
wherein
at least one peripheral portion of the outlet edge is arranged in a manner displaceable inwards and outwards transversely to the axis of the outlet and can be adjusted inwards and outwards by an adjustment device.

2. The device according to claim 1,
wherein
the peripheral portion is formed by a slider, which is mounted in the die relief in a manner displaceable transversely to the axis of the outlet between an inner and outer position within a guide, wherein, at least in the inner position, the slider projects into the outlet cross-section of the outlet.

3. The device according to claim 2,
wherein
in its outer position, the slider also projects into the outlet cross-section or releases the outlet cross-section.

4. The device according to claim 2,
wherein
the outlet provides at least one edge recess extending into the outlet edge, of which the cross-section can be increased or reduced by the slider.

5. The device according to claim 2,
wherein
the slider provides a flat lateral surface at its end facing away from the extrusion direction and, with this lateral surface, is in contact with a guide surface of the die relief.

6. The device according to claim 2,
wherein
the slider is a flat slider, the broad sides of which extend transversely to the axis of the outlet.

7. The device according to claim 2,
wherein
the slider is disposed at the front side of the die relief facing in the extrusion direction.

8. The device according to claim 2,
wherein
the front-end of the slider facing towards the axis of the outlet is undercut towards the extrusion direction.

9. The device according to claim 5,
wherein
the guide is arranged through a recess in the die relief or in the front part attached to the die relief.

10. The device according to claim 1,
wherein
the outlet of the die relief provides a square or oblong, preferably rectangular cross-sectional shape, wherein the upper and lower sides of this cross-sectional shape are preferably broad sides.

11. The device according to claim 1,
wherein
one or two or more, for example, three, adjustable peripheral portions are disposed on at least one or more sides or on all sides of the outlet.

12. The device according to claim 11,
wherein
in each case, one or more adjustable peripheral portions are disposed on three sides of the outlet.

13. The device according to claim 1,
wherein
no adjustable peripheral portion is disposed on the lower side of the outlet.

14. The device according to claim 2,
wherein
a common drive device is allocated to the slider/s disposed on at least one side of the outlet or to the sliders disposed on several sides of the outlet.

15. The device according to claim 1,
wherein
a cutting device, with which a block can be cut from the slab, is allocated to the die relief.

16. The device according to claim 15,
wherein
a rate meter determining the output rate of the slab and a control device, which controls the cutting dependent upon the output rate, are allocated to it.

17. A block, especially for the construction industry, especially, a brick, which comprises a material extrudable in an extrusion direction and subsequently hardenable and which provides a material stud formed during the extrusion on at least one of its sides extending in the extrusion direction,
wherein
the material stud provides a spacing distance from at least one of the end surfaces of the block extending transversely to the extrusion direction.

18. The block according to claim 17,
wherein
it provides respectively one or more material studs on one side or on two or three sides or on all sides

19. The block according to claim 17,
wherein
on each side or on each of the sides, the block provides two material studs, which provide a spacing distance from one another preferably extending parallel to the end surfaces.

20. The block according to claim 17,
wherein
viewed in the direction towards its end surfaces, it provides an oblong, especially rectangular cross-sectional shape.

21. The block according to claim 20,
wherein
viewed in the direction towards its end surfaces, it provides a length, which is greater than its width.

22. The block according to claim 21,
wherein
the material studs are disposed on a broad side and a narrow side of the block, or also on the opposing narrow side or on all sides.

23. The block according to claim 22,
wherein
the material stud/studs on the one side, for example, a narrow side, of the block are offset relative to the material stud/studs of the opposing side, for example, a narrow side, in such a manner that, viewed in the projection at right angles to the respective side, the material studs/studs of the one side are disposed side-by-side with the material stud/studs of the other side.
